(19) United States
(12) Patent Application Publication
(10) Pub. No.: US 2013/0259585 A1
(43) Pub. Date: Oct. 3, 2013

(54) MILLING CUTTER

(71) Applicants: HONG FU JIN PRECISION INDUSTRY (ShenZhen) CO., LTD., (US); HON HAI PRECISION INDUSTRY CO., LTD., New Taipei (TW)

(72) Inventors: Long XU, Shenzhen (CN); Yi-Min JIANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/851,947

(22) Filed: Mar. 27, 2013

(30) Foreign Application Priority Data
Apr. 3, 2012 (CN) 201210095698.0

(51) Int. Cl. B23C 5/10

(52) U.S. Cl. CPC B23C 5/10
USPC 407/54

(57) ABSTRACT

A cutter for milling of workpiece includes a cutter body, a first cutting portion, and a second cutting portion formed between the cutter body and the first cutting portion. The first cutting portion carries out primary machining on the workpiece. The first and second cutting portions extend in opposite twists or helixes along a central axis of the cutter body and are rotated in opposite directions during machining.

### BACKGROUND

1. Technical Field

The present disclosure relates generally to a milling cutter and, more particularly, to a milling cutter, which is capable of performing rough or primary machining and precision machining at the same time.

2. Description of Related Art

In milling, a plurality of burrs may be generated by a milling cutter. To obtain a surface with high quality on a workpiece, the workpiece may require another machining process and another cutter for removing the burrs. During the two machining processes in milling, the first and second milling cutters must be exchanged, and a position of the second milling cutter used must be adjusted to find a proper starting point or work point. Thus, milling is performed by alternating between using the different (first and second) milling cutters, and adjusting the positions of the milling cutters, which takes or consumes more time, thereby decreasing the overall working efficiency and the working precision.

Therefore, there is room for improvement within the art.

### BRIEF DESCRIPTION OF THE DRAWINGS

The elements in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a cutter having a cutting portion.

FIG. 2 is similar to FIG. 1, but viewed from another aspect.

FIG. 3 is an enlarged view of a circular part II of FIG. 1

FIG. 4 is a top plan view of an end of the cutting portion of the cutter of FIG. 1.

### DETAILED DESCRIPTION

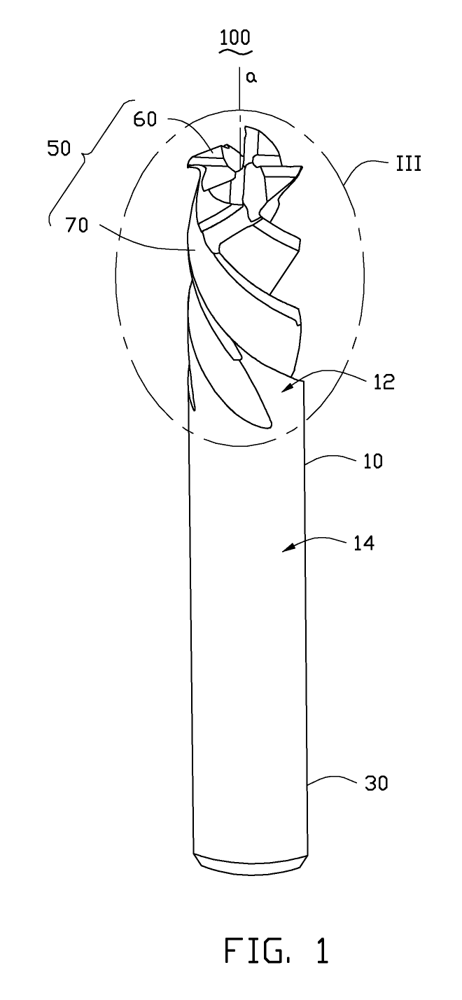

FIG. 1 shows an embodiment of a cutter 100. The cutter 100 includes a cutter body 10, a cutter handle 30, and a cutting portion 50. The cutter handle 30 and the cutting portion 50 are formed at opposite ends of the cutter body 10.

In the illustrated embodiment, the cutter body 10 is substantially cylindrical, and defines a central axis α. In machining, the cutter body 10 rotates about the central axis α. The cutter body 10 includes a first end 12 and a second end 14 formed at an end of the first end 12. The cutting portion 50 is formed at the first end 12 of the cutter body 10, and the cutter handle 30 is formed at the second end 14 of the cutter body 10.

The cutter handle 30 can have a straight shank or a tapered shank. The cutter handle 30 is used for attaching the cutter 100 to a main shaft (not shown) of a computer numerical control machine (not shown).

The cutting portion 50 includes a first cutting portion 60 and a second cutting portion 70 connected to the first cutting portion 60. The first cutting portion 60, the second cutting portion 70, and the cutter body 10 are aligned along the central axis α. The first cutting portion 60 is adjacent to the second cutting portion 70 along the central axis α. The first cutting portion 60 extends toward the cutter handle 30 in a helix shape along the central axis α of the cutter body 10. The second cutting portion 70 extends toward the cutter handle 30 along the central axis α of the cutter body 10 in a helix shape. In the illustrated embodiment, a helical direction of the first cutting portion 60 and a helical direction of the second cutting portion 70 are opposite of each other. A distance between the first cutting portion 60 and the cutter body 10 is greater than a distance between the second cutting portion 70 and the cutter body 10. A length of the first cutting portion 60 along the central axis α is equal to or slightly smaller than a length of the second cutting portion 70 along the central axis α. The first cutting portion 60 is used for the rough or primary machining of a workpiece (not shown), and the second cutting portion 70 removes burrs being created on the portion of the workpiece which has been cut during the primary milling performed by the first cutting portion 60.

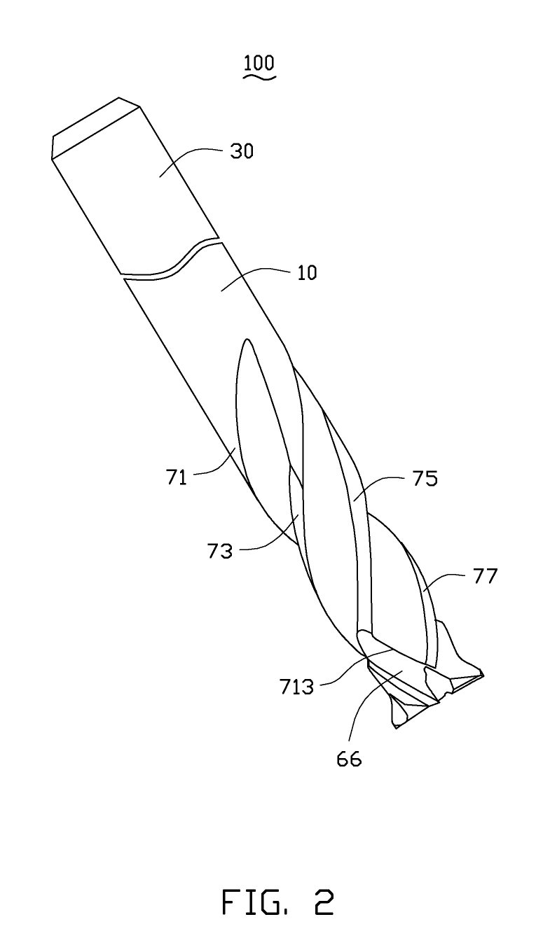

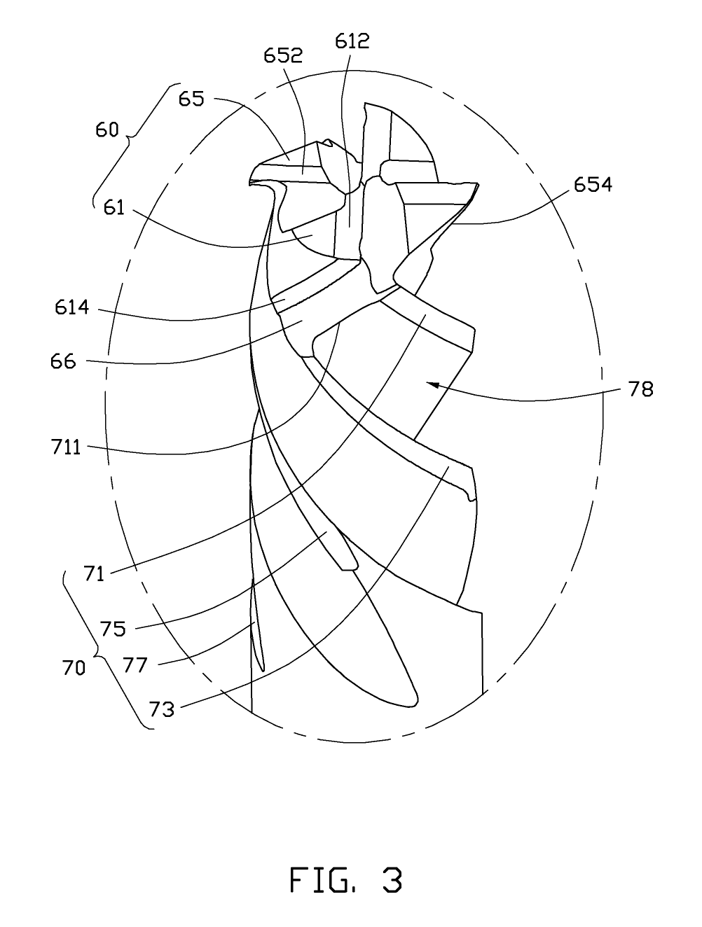

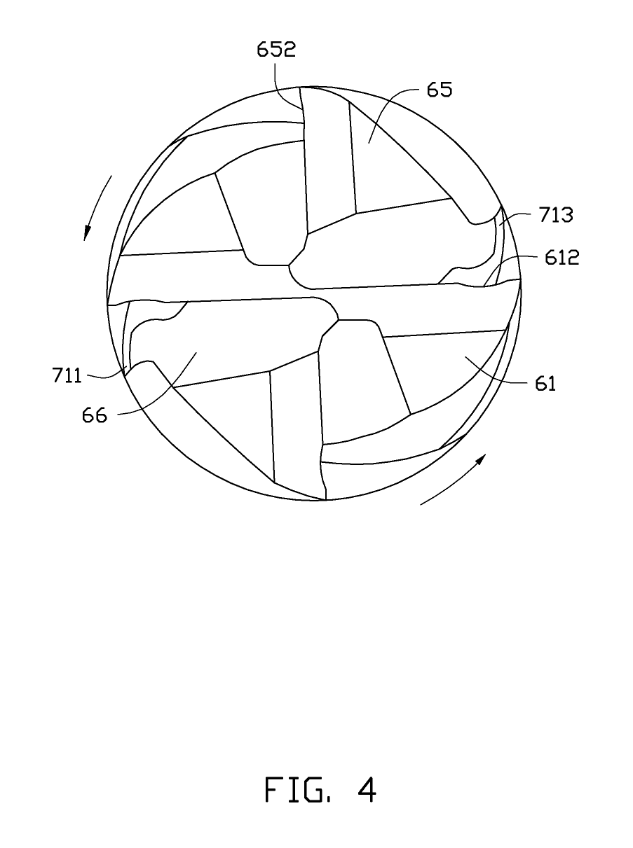

Referring to FIGS. 2 through 4, the first cutting portion 60 includes two lead cutting edges 61 and two side cutting edges 65. The two lead cutting edges 61 and the two side cutting edges 65 are alternately arranged in an end surface of the first cutting portion 60 along a circumferential direction of the first cutting portion 60, and helically extend toward the cutter handle 30 along the central axis α. A first helical groove 66 is defined between one of the two lead cutting edges 61 and one of the two side cutting edges 65 next to the lead cutting edge 61, to facilitate the discharge of metal chips and dissipation of heat produced in machining process. Each of the two lead cutting edges 61 includes an end edge 612 in an end surface thereof, and a circumferential edge 614 connected to the end edge 612. The end edge 612 is substantially straight. The circumferential edge 614 extends helically along the central axis α. The side cutting edge 65 includes an end edge 652 and a circumferential edge 654 connected to the end edge 652. A cutting edge radius of the end edge 652 of the side cutting edge 65 is equal to or slightly greater than a cutting edge radius of the end edge 612 of the lead cutting edge 61. As such, the end edge 612 is used for primary machining, and the end edge 652 is used for precision machining. The circumferential edge 654 has the same structure as that of the circumferential edge 614 of the lead cutting edge 61.

The second cutting portion 70 includes a first cutting edge 71, a second cutting edge 73, a third cutting edge 75, and a fourth cutting edge 77. The four cutting edges 71, 73, 75, 77 helically extend from the first end 12 of the cutter body 10 along the central axis α. The first cutting edge 71 is adjacent to the second cutting edge 73. A first cutting end edge 711 is formed between the first cutting edge 71 and the second cutting edge 73, and is adjacent to one first helical groove 66. The third cutting edge 75 is located adjacent to the fourth cutting edge 77. A second cutting end edge 713 located opposite to the first cutting end edge 711 is formed between the third cutting edge 71 and the fourth cutting edge 77, and is adjacent to another first helical groove 66. In the machining process, the first cutting end edge 711 and the second cutting end edge 713 are capable of removing the burrs created by the two lead cutting edges 61 and the two side cutting edges 65 of the first cutting portion 60, along a cutting direction thereof.

During machining, the cutter 100 rotates along the central axis α. Because the direction of twist of the second cutting portion 70 is opposite to the direction of twist of the first cutting portion 60, and the cutting direction which is applied to the second cutting portion 70 is the reverse cutting direction when burrs were generated, and the burrs created are removed by the second cutting portion 70. The processes of having to alternating cutter installation for usage or the re-positioning the workpiece upon installation of a new cutter are simply not needed, such that labour hours can be greatly decreased, and the working efficiency is increased. Further, any error introduced by having to re-position the second cutter can be avoided, and the working precision for milling can be greatly increased.

The quantities of the lead cutting edges 61 and of the side cutting edges 65, respectively, of the first cutting portion 60 can be changed according to a size or the manufacturing difficulty of the cutter 100, for example, the total number of the lead cutting edges 61 or the side cutting edges 65 can be two, or four, or eight. The lead cutting edges 61 and the side cutting edges 65 can be arranged non-uniformly in the end surface of the first cutting portion 60 along the circumferential direction thereof. Shapes of the lead cutting edge 61 and the side cutting edge 65 can be changed according to a surface shape of the workpiece to be machined.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A cutter configured for milling of a workpiece, comprising:
a cutter body;
a first cutting portion configured for primary machining of the workpiece; and
a second cutting portion formed between the cutter body and the first cutting portion, wherein the first cutting portion extends along a central axis of the cutter body in a helix shape, the second cutting portion extends along the central axis of the cutter body in a helix shape, and a helical direction of the first cutting portion and a helical direction of the second cutting portion are opposite of each other.

2. The cutter of claim 1, wherein a length of the first cutting portion along the central axis is equal to or smaller than a length of the second cutting portion along the central axis.

3. The cutter of claim 1, wherein the first cutting portion comprises two lead cutting edges and two side cutting edges, and the two lead cutting edges and the two side cutting edges are alternately arranged in an end surface of the first cutting portion along a circumferential direction of the first cutting portion.

4. The cutter of claim 3, wherein a first helical groove is defined between one of the two lead cutting edges and one of the two side cutting edges next to the lead cutting edge.

5. The cutter of claim 4, wherein each of the two lead cutting edges comprises an end edge in an end surface thereof, and a circumferential edge connected to the end edge of the each of the two lead cutting edges, and the circumferential edge of the each of the two lead cutting edges extends helically along the central axis; each of the two side cutting edges comprises an end edge in an end surface thereof, and a circumferential edge connected to the end edge of the each of the two side cutting edges, and the circumferential edge of the each of the two side cutting edges extends helically along the central axis.

6. The cutter of claim 5, wherein a cutting edge radius of the end edge of the each of the two side cutting edges is equal to or slightly greater than a cutting edge radius of the end edge of the each of the two lead cutting edges.

7. The cutter of claim 4, wherein the second cutting portion comprises a first cutting edge and a second cutting edge adjacent to the first cutting edge, the first cutting edge and the second cutting edge helically extend from the cutter body along the central axis, respectively, a first cutting end edge is formed between the first cutting edge and the second cutting edge, and the first cutting end edge is adjacent to one corresponding first helical groove.

8. The cutter of claim 7, wherein the second cutting portion further comprises a third cutting edge and a fourth cutting edge adjacent to the third cutting edge, the third cutting edge and the fourth cutting edge helically extend from the cutter body along the central axis, respectively, a second cutting end edge located opposite to the first cutting end edge is formed between the third cutting edge and the fourth cutting edge, and the second cutting end edge is adjacent to another corresponding first helical groove.

9. A cutter configured for milling of a workpiece, comprising:
a cutter body;
a cutting portion connected to one end of the cutter body, wherein the cutting portion comprises a first cutting portion configured for primary machining and a second cutting portion formed between the cutter body and the first cutting portion; and
a cutter handle connected to the other end of the cutter body opposite to the cutting portion, wherein the first cutting portion extends along a central axis of the cutter body in a helix shape, the second cutting portion extends along the central axis of the cutter body in a helix shape, and a helical direction of the first cutting portion and a helical direction of the second cutting portion are opposite of each other.

10. The cutter of claim 8, wherein a length of the first cutting portion along the central axis is equal to or smaller than a length of the second cutting portion along the center axis.

11. The cutter of claim 8, wherein the first cutting portion comprises two lead cutting edges and two side cutting edges alternately arranged in an end surface of the first cutting portion along a circumferential direction of the first cutting portion.

12. The cutter of claim 11, wherein a first helical groove is defined between one of the two lead cutting edges and one of the two side cutting edges next to the lead cutting edge, to facilitate the discharge of metal chips and dissipation of heat produced in machining process.

13. The cutter of claim 12, wherein each of the two lead cutting edges comprises an end edge in an end surface thereof, and a circumferential edge connected to the end edge of the each of the two lead cutting edges, and the circumferential edge of the each of the two lead cutting edges extends helically along the central axis; each of the two side cutting edges comprises an end edge in an end surface thereof, and a circumferential edge connected to the end edge of the each of the two side cutting edges, and the circumferential edge of the each of the two side cutting edges extends helically along the central axis.

14. The cutter of claim 13, wherein a cutting edge radius of the end edge of the each of the two side cutting edges is equal to or slightly greater than a cutting edge radius of the end edge of the each of the two lead cutting edges.

15. The cutter of claim 12, wherein the second cutting portion comprises a first cutting edge and a second cutting edge adjacent to the first cutting edge, the first cutting edge and the second cutting edge helically extend from the cutter body along the central axis, respectively, a first cutting end edge is formed between the first cutting edge and the second cutting edge, and the first cutting end edge is adjacent to one corresponding first helical groove.

16. The cutter of claim 15, wherein the second cutting portion further comprises a third cutting edge and a fourth cutting edge adjacent to the third cutting edge, the third cutting edge and the fourth cutting edge helically extend from the cutter body along the central axis, respectively, a second cutting end edge, opposite to the first cutting end edge, is formed between the third cutting edge and the fourth cutting edge, and the second cutting end edge is adjacent to another corresponding first helical groove.
